(19) United States
(12) Patent Application Publication
(10) Pub. No.: US 2022/0250070 A1
(43) Pub. Date: Aug. 11, 2022

(54) VORTEX PARTICLE SEPARATION

(71) Applicant: Hewlett-Packard Development Company, L.P., Spring, TX (US)

(72) Inventors: Viktor Shkolnikov, Palo Alto, CA (US); Chien-Hua Chen, Corvallis, OR (US); Daixi Xin, Palo Alto, CA (US)

(73) Assignee: Hewlett-Packard Development Company, L.P., Spring, TX (US)

(21) Appl. No.: 17/415,213

(22) PCT Filed: Sep. 14, 2019
(86) PCT No.: PCT/US2019/051199

§ 371 Date: Jun. 17, 2021

(51) Int. Cl. B01L 3/00; B03C 5/02

(52) U.S. Cl. CPC B01L 3/502761; B03C 5/026; B01L 3/502776; B01L 2300/0645; B01L 2200/0652; B01L 2400/0424; B01L 3/502753

(57) ABSTRACT

A fluid entrained particle separation system may include a particle separator, a main fluid passage extending along an axis to guide translational fluid flow along the axis to the particle separator and a side fluid inlet connected to the main fluid passage to generate a vortex about the axis. The vortex concentrates less dense material in the fluid flow towards the axis.

### BACKGROUND

The separation of particles is performed various industries. For example, in biology and medicine, rare cells are often separated from a patient's blood for diagnosis. The separation of particles, such as rare blood cells, presents many challenges.

### BRIEF DESCRIPTION OF THE DRAWINGS

FIG. 1 is a schematic diagram illustrating portions of an example fluid entrained particle separation system.

FIG. 2 is a flow diagram of an example particle separation method.

FIG. 3 is a schematic diagram illustrating portions of an example fluid entrained particle separation system.

FIG. 4 is a perspective view schematically illustrating portions of an example fluid entrained particle separation system.

FIG. 5 is a perspective view schematically illustrating portions of an example fluid entrained particle separation system.

FIG. 6A is a perspective view illustrating portions of an example fluid entrained particle separation system.

FIG. 6B is a sectional view of the example fluid entrained particle separation system of FIG. 6A take along line 6B-6B.

FIG. 7 is a schematic diagram illustrating portions of an example fluid entrained particle separation system.

FIG. 8 is a schematic diagram illustrating portions of an example fluid entrained particle separation system.

FIG. 9 is a schematic diagram illustrating portions of an example fluid entrained particle separation system.

Throughout the drawings, identical reference numbers designate similar, but not necessarily identical, elements. The Figs. are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed are example fluid entrained particle separation systems and methods that facilitate the separation and sorting of different particles. The example particle separation systems and methods create a vortex about a flow axis within a main fluid passage to concentrate less dense material towards the axis and higher density material away from the axis. The main flow translates the concentrated less dense material in the higher density material to a downstream particle separator. The use of the vortex to concentrate different particles based upon their different densities enhances the downstream separation by the particle separator. In contrast to systems that separate particles on a batch-by-batch basis, the disclosed systems' creation of a vortex to concentrate heavier particles towards the flow axis of the main fluid passage as the particles are flowing towards a downstream separator may further facilitate the continuous and uninterrupted separation and sorting of particles.

Each of the disclosed example fluid entrained particle separation systems may be embodied as part of a microfluidic chip, wherein the various flow and separation passages comprise microfluidic passages or microfluidic channels. As will be appreciated, examples provided herein may be formed by performing various microfabrication and/or micromachining processes on a substrate to form and/or connect structures and/or components. The substrate may comprise a silicon based wafer or other such similar materials used for microfabricated devices (e.g., glass, gallium arsenide, plastics, etc.). Examples may comprise microfluidic channels, fluid actuators, and/or volumetric chambers. Microfluidic channels and/or chambers may be formed by performing etching, microfabrication processes (e.g., photolithography), or micromachining processes in a substrate. Accordingly, microfluidic passages and/or chambers may be defined by surfaces fabricated in the substrate of a microfluidic device. In some implementations, microfluidic passages and/or chambers may be formed by an overall package, wherein multiple connected package components that combine to form or define the microfluidic passage and/or chamber.

In some examples described herein, a dimension or multiple dimensions of a microfluidic channel and/or capillary chamber may be of sufficiently small size (e.g., of nanometer sized scale, micrometer sized scale, millimeter sized scale, etc.) to facilitate pumping of small volumes of fluid (e.g., picoliter scale, nanoliter scale, microliter scale, milliliter scale, etc.). For example, some microfluidic channels or passages may facilitate capillary pumping due to capillary force. In addition, examples may couple at least two microfluidic channels to a microfluidic output channel via a fluid junction.

Disclosed are example fluid entrained particle separation systems. The example fluid entrained particle separation systems may include a particle separator, a main fluid passage extending along an axis to guide translational fluid flow along the axis to the particle separator and a side fluid inlet connected to the main fluid passage to generate a vortex about the axis. The vortex concentrates less dense material in the fluid flow towards the axis.

Disclosed are example methods for separating particles entrained in a fluid. The Example methods comprise generating a vortex within a fluid flow within a main fluid passage extending along an axis to a particle separator to concentrate less dense material towards the axis. The method further comprises translating the concentrated less dense material along the axis to the particle separator.

Disclosed are example fluid entrained particle separation systems that may include a particle separator, a main fluid passage extending along an axis to the particle separator, a main fluid inlet to supply a translational fluid flow along the axis, a side fluid inlet to generate a vortex within the main fluid passage, a particle supply and a spacing fluid supply. The particle supply is connected to one of the main fluid inlet and the side fluid inlet. The particle supply supplies first particles having a first density and second particles having a second density. The spacing fluid supply is connected to the other of the main fluid inlet and the side fluid inlet. The spacing fluid supply to supply a fluid having a third density between the first density and the second density.

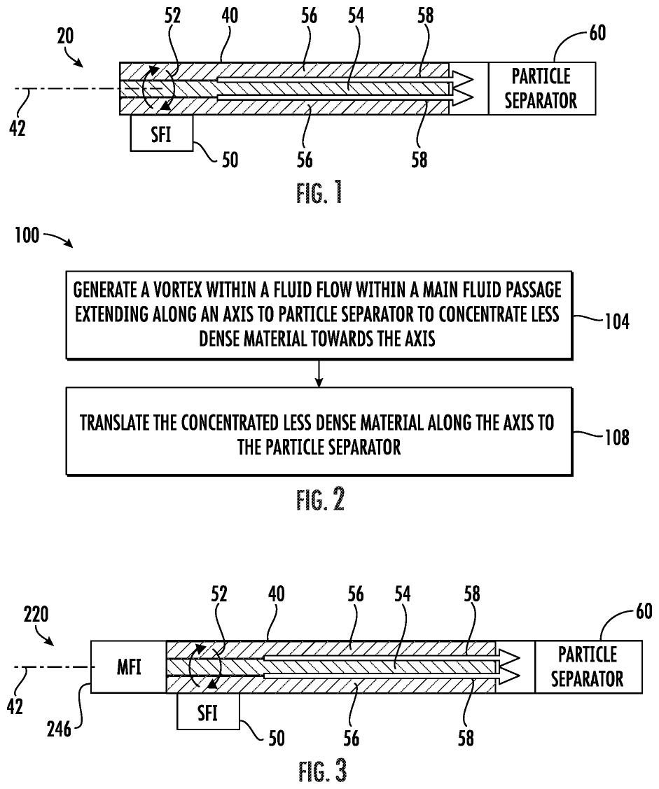

FIG. 1 is a sectional view schematically illustrating portions of an example fluid entrained particle separation system 20. System 20 prepares fluid entrained particles for subsequent particle separation by generating a vortex within the flow of the particles along a main fluid passage towards a particle separator, wherein the vortex concentrates lighter particles or particles having a lower density towards a center of the vortex and concentrates heavier particles or particles having a greater density away from the center of the vortex. The concentration of different particles in different regions within the main fluid passage facilitates enhanced subsequent downstream particle separation. Because such concentration is performed as the fluid is flowing along the fluid passage towards the particle separator, such concentration and subsequent separation may be carried out in a continuous fashion in contrast to a batch-based separation. System 20 comprises main fluid passage 40, side fluid inlet 50 and particle separator 60.

Main fluid passage 40 extends along an axis 42 to guide the translational flow of fluid along axis 42 to particle separator 60. Although illustrated as being generally linear, in other implementations, main fluid passage 40 may be curved or angled. In one implementation, the interior sides of main fluid passage 40 may be curved to facilitate the formation of a vortex about axis 42.

Side fluid inlet (SFI) 50 is connected to main fluid passage 40 so as to generate a vortex 52 about axis 42. Side fluid inlet 50 directs a stream or flow of fluid into main fluid passage 40 in a direction nonparallel to axis 42. In one implementation, the flow of fluid into main passage 40 from side fluid inlet 50 encounters the opposing interior wall of main fluid passage 40 and turns, creating vortex 52. As schematically illustrated by stippling, the created vortex 52 concentrate less dense material 54, such the lighter particles, in the fluid flow towards axis 42. At the same time, the created vortex 52 concentrates the higher density material 56, such as the heavier particles, in the fluid flow away from axis 42 towards the interior side walls of main fluid passage 40. As indicated by arrows 58, the core flow of lighter particles or material 54 and the outer ring flow of heavier particles or material 56 is further translated along main fluid passage 40 in a direction parallel to axis 42, towards particle separator 60. In system 20, as well as in each of the following implementations, the vortex 52 may dissipate and the stream lines may straighten as they approach particle separator 60.

In the example illustrated, side fluid inlet 50 supplies all the fluid being moved and guided along main fluid passage 50. In other implementations, as will be described hereafter, system 20 may include additional side fluid inlets located on different sides of axis 42, opposite to inlet 50 or downstream from inlet 50. In other implementations, as will be described hereafter, system 20 may include a main fluid inlet which supplies fluid into main fluid passage 40 in a direction parallel to and along axis 42. In such alternative implementations, as will be described hereafter, selected fluid inlets may supply the particles of interest to be separated while another fluid inlet or inlets may supply other fluids not containing any particles for separation, such as additional spacing fluids that facilitate the subsequent separation of the different particles by particle separator 60.

Particle separator 60 (schematically shown) comprises a device that physically separates and sorts selected particles out of the stream a fluid flowing through main fluid passage 40. Such separation is facilitated by the concentration of different particles into different regions of the stream flowing through main fluid passage 40. In one implementation, particle separator 60 may comprise a pair of concentric or near concentric separation passages. An inner passage receives the concentrated less dense material exiting main fluid passage 40. An outer passage receives the concentrated greater dense material exiting main fluid passage 40. In another implementation, particle separator 60 may comprise a separator that separates particles based upon size and polarization properties using dielectrophoresis. In other implementations, particle separator 60 may separate particles using antibodies and other markers. In yet other implementations, particle separator 60 may separate different particles from one another using filtering devices or other separation techniques.

FIG. 2 is a flow diagram of an example particle separation method 100. As indicated by block 104, a vortex is generated within a fluid flow within a main fluid passage extending along an axis to a particle separator. The vortex is generated so as to concentrate less dense material towards the axis.

As indicated by block 108, the concentrated less dense material within the main fluid passage is translated along the axis to the particle separator. In other words, both the vortex and the translational fluid flow of the entrained particles to the particle separator occurs within the same main fluid passage. The concentration of different particles in different regions of the main fluid passage relative to or about the axis facilitates enhanced separation of particles by the downstream particle separator. The generation of the vortex in the same main fluid passage along which the particle is directed to the downstream particle separator facilitates continuous particle separation processes as compared to batch processes.

FIG. 3 is a sectional view schematically illustrating portions of an example fluid entrained particle separation system 220. System 220 is similar to system 20 described above except that system 220 is additionally illustrated as specifically comprising a main fluid inlet 246. Those remaining components of system 220 which correspond to components of system 20 are numbered similarly.

Main fluid inlet 246 comprise an inlet through which fluid is supplied in a direction along axis 42 upstream of side fluid inlet 50. Side fluid inlet 50 is located between main fluid inlet 246 and particle separator 60 in a direction along axis 42. In one implementation, main fluid inlet 246 supplies fluid to main fluid passage 40 in a direction parallel to axis 42. The fluid supplied by main fluid inlet 246 is interacted upon by the fluid entering through side fluid inlet 50 so as to generate vortex 52 that concentrates differently weighted particles or different density particles in different circumferential rings or regions about axis 42.

In one implementation, the particles of interest or target particles to be separated from other particles and other fluids are supplied to main fluid passage 40 through side fluid inlet 50 while additional non-target particle fluid, omitting the targeted particles, is supplied to main fluid inlet 246 to facilitate the translational flow along main fluid passage 40. As will be described hereafter, in some implementations, the non-target particle fluid may comprise a spacing fluid specifically chosen based upon its density so as to assist in spacing the targeted particles from any non-targeted particles flowing through main fluid passage 40.

In one implementation, the targeted particles to be separated from other particles and other fluids are supplied to main fluid passage 40 through main fluid inlet 246. The additional non-target particle fluid may be supplied through side fluid inlet 50. In still other implementations, the targeted particles to be separated from other particles other fluids may be supplied to main fluid passage 40 through both side fluid inlet 50 and main fluid inlet 246.

FIG. 4 is a perspective view schematically illustrating portions of an example particle separation system 320. System 320 is similar to system 220 except that system 320 is illustrated as having a fluid passage 340 having a generally rectangular cross-sectional shape and that particle separation system 320 comprises a pair of side fluid inlets 350-1, 350-2 (collectively referred to as inlets 350). FIG. 4 illustrates how multiple side fluid inlets 350 may be utilized to generate stronger vortices 52 to facilitate the concentration of differently weighted or different density materials and particles within the fluid flow.

Side fluid inlets 350 are sandwiched between main fluid inlet 246 and particle separator 60 along main fluid passage 340. Although main fluid passage 340 is illustrated as extending along a linear axis 42 and as having a square or rectangular cross-sectional shape, in other implementations, main fluid passage 340 may be curved, angled or the like and may have non-rectangular cross-sectional shapes. Side fluid passages 350 direct the inflow of fluid into main fluid passage 340 in the directions indicated by arrows 362.

As shown by FIG. 4, side fluid passages 350 are opposed to one another on opposite sides of axis 42 and are offset with respect to axis 42. In the example illustrated, the inflow of fluid as indicated by arrow 362 occurs within a single vertical plane perpendicular to axis 42, with the inflow of fluid through inlet 350-1 being vertically above axis 42 and the inflow of fluid through inlet 350-2 being vertically below axis 42. As a result, side fluid passages 350 cooperate with one another to generate an enhanced vortex having enhanced particle concentration. In yet other implementations, the inflow of fluid, as indicated by arrow 362, occurs within a single vertical plane perpendicular to axis 42, wherein the inflow of fluid through inlet 350-1 is in front of axis 42 (as seen in FIG. 4) and the inflow of fluid through inlet 350-2 is behind axis 42 (as seen in FIG. 4).

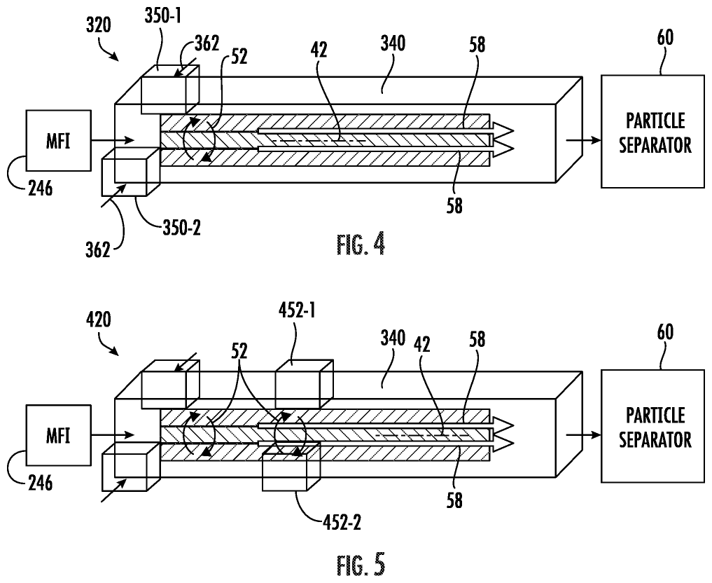

FIG. 5 is a perspective view schematically illustrating portions of an example fluid entrained particle separation system 420. System 420 is similar to system 320 described above except that system 420 comprises a second pair of offset side fluid inlets 452-1, 452-2 (collectively referred to as inlets 452). Those remaining components of system 420 which correspond to components of system 320 are numbered similarly. FIG. 5 illustrates how multiple side fluid inlets may be spaced along axis 42 to generate an elongate vortex 52 that extends along axis 42 for a greater length along main fluid passage 340.

Side fluid inlets 452 are similar to side fluid inlets 350 except that side fluid inlets 452 are located downstream from inlets 350, closer to particle separator 60. Side fluid inlets 452 cooperate with side fluid inlets 350 to create a longer more elongate vortex 52 extending along axis 42. As a result, the concentration of lighter, less dense particles along or towards axis 42 and the concentration of heavier, more dense particles away from axis 42 is enhanced. As a result, subsequent particle separation by particle separator 60 may also be enhanced.

In one implementation, the particles of interest or target particles to be separated from other particles and other fluids are supplied to main fluid passage 40 through any of side fluid inlets 350 and/or 452 while additional non-target particle fluid, omitting the targeted particles, is supplied to main fluid inlet 246 to facilitate the translational flow along main fluid passage 40. In some implementations, all of inlet 350, 452 may supply fluid containing particles of interest to be separated. In some implementations, some of inlets 350, 452 may supply fluid containing particles of interest to be separated while others of inlets 350, 452 supply non-target particle fluid. As discussed above, in some implementations, the non-target particle fluid may comprise a spacing fluid specifically chosen based upon its density so as to assist in spacing the targeted particles from any non-targeted particles flowing through main fluid passage 40.

In one implementation, the targeted particles to be separated from other particles and other fluids are supplied to main fluid passage 40 through main fluid inlet 246. The additional non-target particle fluid may be supplied through side fluid inlets 350, 452. In still other implementations, the targeted particles to be separated from other particles or other fluids may be supplied to main fluid passage 40 through all of the inlets 246, 350 and 452.

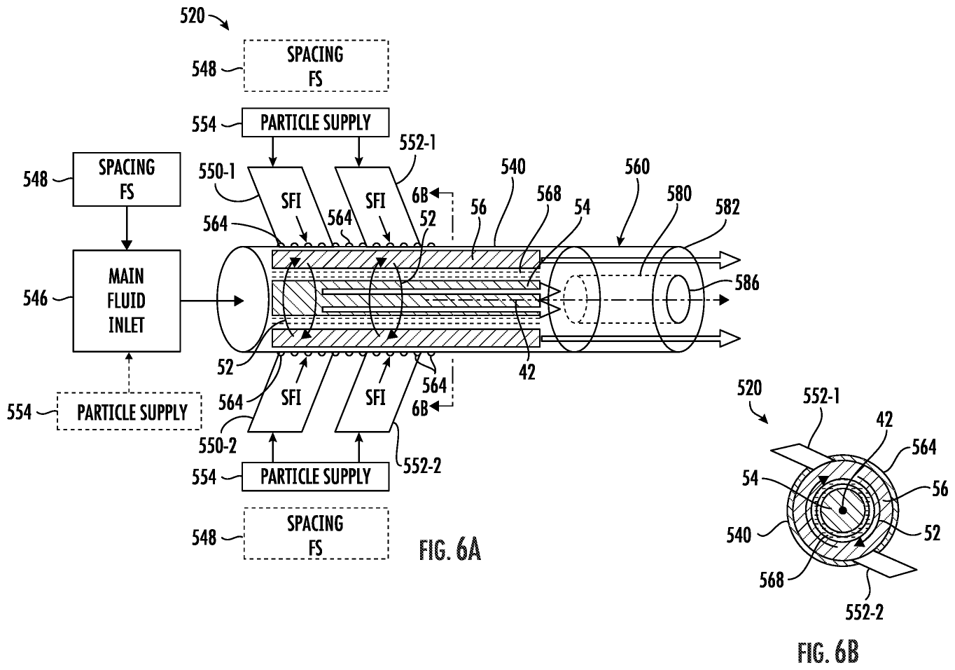

FIGS. 6A and 6B illustrate portions of an example fluid entrained particle separation system 520. FIG. 6A is a perspective view of system 520 with portions schematically illustrated. FIG. 6B is a sectional view taken along line 6B-6B of FIG. 6A. System 520 illustrates the use of a spacing fluid and a particular example of a downstream particle separator. System 520 comprises main fluid passage 540, main fluid inlet 546, spacing fluid supply 548, side fluid inlets 550-1, 550-2 (collectively referred to as inlets 550), 552-1, 552-2 (collectively referred to as inlets 552), particle supply 554 and particle separator 560.

Main fluid passage 540 is similar to main fluid passage 40 described above except that main fluid passage 540 is shaped to facilitate vortex flow. In the example illustrated, the interior side walls of main fluid passage 50 are curved. In one implementation, main fluid passage 50 is cylindrical. In the example illustrated, the interior side walls of main fluid passage 50 are further rifled. Main fluid passage 540 has an interior surface including a helical groove 564 extending along axis 42 and having an angled orientation (with respect axis 42) generally corresponding to vortex 52. In other implementations, main fluid passage 540 may omit one or both of the curved interior walls or the rifling.

Main fluid inlet 546 is similar to main fluid inlet 246 described above. Main fluid inlet 546 supplies fluid to main fluid passage 540 in a direction generally along axis 42. Spacing fluid supply 548 supplies fluid through main fluid inlet 546. Spacing fluid supply 548 supplies a fluid having a density between the densities of two different particles entrained in the fluid that are to be separated from one another. As shown by dashed stippling, the intermediate density of spacing fluid spaces and provides an intermediate buffer or spacing layer 568 between the concentration of lighter density material 54 and the concentration of heavier density material 56. As will be described hereafter, this intermediate spacing layer 568 reduces the likelihood of the lighter and heavier particles co-mingling to enhance subsequent particle separation.

For example, in one implementation in which white blood cells and other cells (having a first lower density) are to be separated from red blood cells (having a second higher density), spacing fluid supply 540 may supply fluid having a third density greater than the first lower density but less than the second higher density. In one implementation, the spacing fluid may comprise 70% Percoll in water, wherein such a spacing fluid has a density greater than the density of the white blood cells and other rare cells, but less than the density of the red blood cells. Percoll comprises colloidal silica particles of 15 to 30 nm diameter (23% weight for weight in water) which have been coated with polyvinylpyrrolidone (PVP). PVP is non-toxic for cells. The PVP percentage in the spacing fluid supplied by supply 540 may be adjusted depending upon the type of cells or particles being isolated are separated. In other implementations, the spacing fluid may comprise sucrose that is been adjusted for appropriate osmolality to maintain physiologically-relevant cell characteristics. In still other implementations, other spacing fluids may be utilized. As should be appreciated, the selection of the spacing fluid supplied by supply 548 may vary depending upon the particles to be separated from one another by system 520.

Side fluid inlets 550 and 552 are similar to side fluid inlets 450 and 452 described above except that inlets 550 and 552 are each angled relative to one another and to axis 42 to enhance vortex flow and corresponding particle concentrating. As shown by FIG. 6B, side fluid inlets 552-1 and 552-2 each direct fluid into main fluid passage 540 in a direction tangential to axis 42 and clockwise about axis 42. In other implementations, inlets 552 may direct fluid into main fluid passage 540 in a direction tangential to axis 42 and counterclockwise about axis 42. Each of the side fluid inlets 552 is to direct fluid flow into the main fluid passage 540 at an angle oblique to a horizontal (or vertical) plane intersecting the axis 42. In one implementation, inlets 552 direct fluid flow into main fluid passage 540 along axes that are oblique to one another. In some implementations, side fluid inlets 552 may additionally be angled in a downstream direction along axis 42, towards particle separator 560, to additionally facilitate translational fluid flow towards particle separator 560. In the example illustrated, side fluid inlets 550 are angled in a similar fashion. In other implementations, less than all of side fluid inlets 550, 552 may be angled.

Particle supply 554 is connected to each of side fluid inlets 550, 552. Part supply 554 supplies a fluid containing different particles to be separated from one another. For example, in one implementation, particle supply 54 supplies a fluid containing both red blood cells, white blood cells and/or other cells. As indicated by broken lines, in some implementations, particle supply 554 may alternatively supply the fluid entrained particles to main fluid inlet 546 while spacing fluid supply 548 supplies a spacing fluid to side fluid inlets 550, 552. In some implementations, a portion of side fluid inlets 550, 552 may receive the fluid entrained particles while another portion of side fluid inlets 550, 552 may receive the spacing fluid.

Particle separator 560 physically separates and physically spaces the different particles being separated from one another by intervening walls or chambers. In the example illustrated, particle separator 560 comprises a first separation passage 580 extending from main fluid passage 542 received the less dense material, less dense particles 54 concentrated along axis 42. Particle separator 560 further comprises a second separation passage 582 extending from the main fluid passage 540 and located to receive material other than the less dense material 54, generally the particles and fluid having a greater density. Separation passage 580 is generally located about and adjacent to axis 42 while separation passage 582 circumscribes (extending radially outside of) or extends about the exterior of separation passage 580. As a result, the lower density material and/or particles 54 are separated from the higher density material and/or particles 56 by at the intervening wall 586. Following such separation, the conduit forming separation passage 586 may guide and direct the flow of the less density material/particles to a first location for further separation, processing or disposal while the outer conduit forming the separation passage 582 may guide and direct the flow of the greater density material/particles to a second different location further separation, processing or disposal.

In the example illustrated, the intervening wall 586 separating passages 580 and 582 intersects the cylindrical ring of fluid forming spacing layer 568. The radius of separation passage 582 may be chosen based upon the force of the vortex 52 being generated, the volumetric proportions of spacing fluid to the particle containing fluid being supplied to main channel 540 and the relative densities of the particles being separated such that intervening wall 586 intersects the spacing layer 568 rather than the lighter material 54 or the heavier material 56. As a result, an inner portion of spacing layer 568 may flow into passage 580 while an outer portion of spacing layer 568 may flow into passage 582. Spacing layer 568 helps to reduce the likelihood of any commingling of the lighter material and particles 54 and the heavier material and particles 56 in either of passages 580, 582.

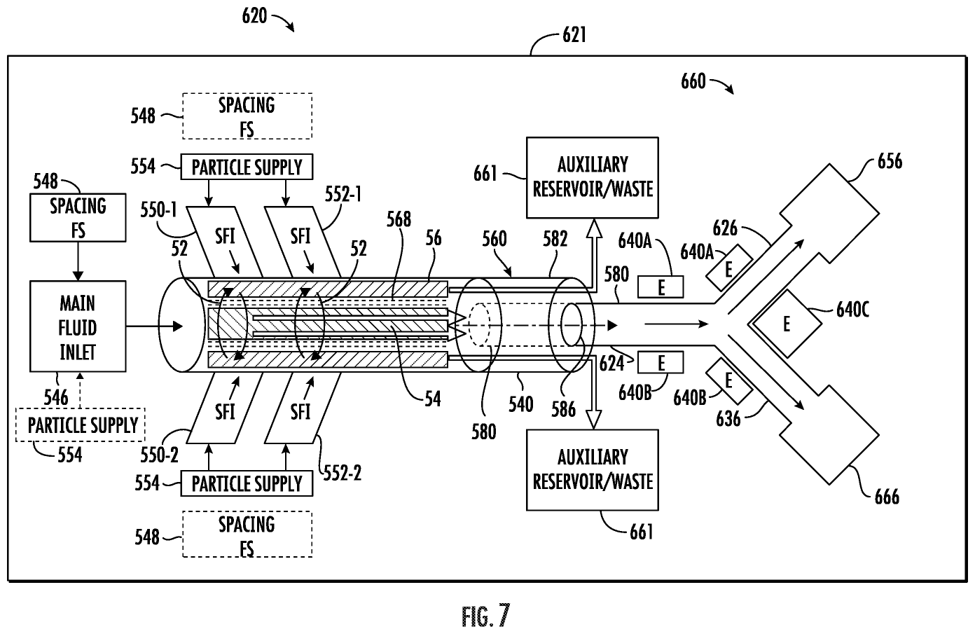

FIG. 7 is a perspective view illustrating portions of an example fluid entrained particle separation system 620, portions of which are schematically shown. In the example illustrated, system 620 is formed as part of a microfluidic chip 621, wherein the fluid channel or passage is comprised microfluidic channel or passages formed on a substantially flat planar base or substrate. In other implementations, system 620 may be formed as separate components which are connected to one another for the channeling of fluid between such components. System 620 is similar to system 520 described above except that system 620 additionally comprises a secondary downstream particle separator 660. Those remaining components of system 620 which correspond to components of system 520 are numbered similarly. Separator 660 comprises an example dielectrophoretic (DEP) particle separator. Separator 660 further separates or divides particles in the fluid stream supplied through separation passage 580. As shown by FIG. 7, the heavier or more dense material and particles flowing through separation passage 582 are further directed to an auxiliary reservoir or waste 661. In the example illustrated, particle separator 660 comprises a hydrodynamic focuser that utilizes spacing layer 568 that surrounds the solution containing the particles to provide such focused flow. In other implementations, particle separator 660 may be in the form of other particle focusers, such as free flow negative dielectrophoresis particle focusers and free flow isotachophoresis particle focusers.

Separator 660 comprises inlet passage 624, separation passage 626, separation passage 636, and electrodes 640A, 640B and 640C (collectively referred to as electrodes 640), Inlet passage 624 comprises a channel, such as a microfluidic channel, that is connected to separation passage 580 and that guides a fluid/solution containing particles to be separated.

Separation passages 626 and 636 comprise channels, such as microfluidic channels that extend from and branch off of inlet passage 624. Separation passages 626, 636 lead to distinct destinations where the separated particles or cells may be collected and analyzed. In the example illustrated, separation passages 626, 636 extend a single plane, such as a single horizontal plane. In some implementations, separation passages 626, 636 extend in the same plane as inlet passage 624. Although passages 626, 636 are illustrated as branching off of inlet passage 624 at angles of 135°, it should be appreciated that passages 626 and 636 may extend at other angles from inlet passage 624.

Electrodes 640 are provided to create electric fields across passages 624, 626 and 636. Electrodes 640 extend in a single plane such that they produce electric fields that extend in the same plane as that of passages 624, 626 and 636. Because the separation passages, the electric field and the dielectrophoretic force extend in a single plane, the separation of particles is more predictable and less chaotic, producing more reliable results.

In the example illustrated, electrodes 640A extend alongside passages 624 and 626. Electrodes 640B extend alongside passages 624 and 636. Electrode 640C extends alongside passages 626 and 636. As should be appreciated, each of electrodes 640 may be a continuous electrode or may be formed by multiple separate elements connected to ground or a source of electrical current, such as an alternating frequency electric current source.

In one implementation, electrodes 640A and 640B are separated by a distance across inlet passage 624 by distance of at least 10 times a diameter of a target particle to be separated. Likewise, electrodes 640A and 640C as well as electrodes 640B and 640C are also separated by distance across separation passages 626 and 636, respectively, by a distance of at least 10 times a diameter of the target particle(s) being separated. This separation reduces the likelihood that the global electric field will not be significantly distorted by the presence of the particle such that similar separations are carried out on all particles in the flow. The different particles and fluids separated by particle separator 660 and flowing through passages 626 and 636 are further directed downstream to particle/fluid collection/disposal ports or reservoirs 656 and 666, respectively.

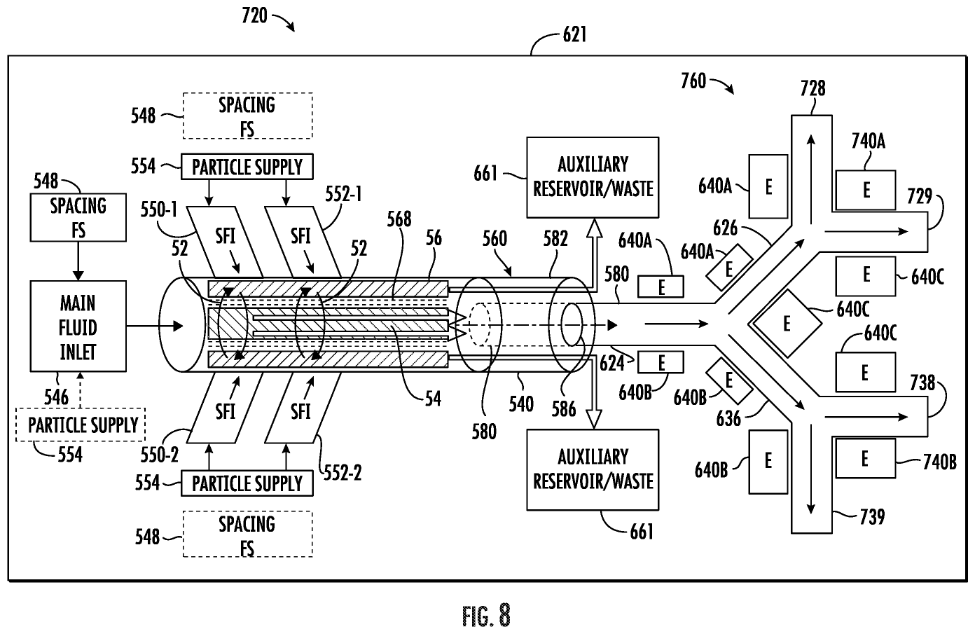

FIG. 8 is a perspective view illustrating portions of an example fluid entrained particle separation system 720, portions of which are schematically shown. System 720 is similar to system 620 described above except that system 720 comprises a particle separator 760 that performs multistage DEP particle separation on the concentrated fluid stream. As shown by FIG. 8, particle separator 760 is similar to particle separator 660 except that particle separator 760 additionally comprises secondary separation passages 728, 729, 738, 739 and electrodes 740A, 740B (collectively referred to as electrodes 740). Those remaining components of system 720 which correspond to components of system 620 are numbered similarly. As the system 620, system 720 is formed as part of a microfluidic chip 621, wherein the fluid channel or passage is comprised microfluidic channel or passages formed on a substantially flat planar base or substrate. In other implementations, system 720 may be formed as separate components which are connected to one another for the channeling of fluid between such components.

Secondary separation passages 728, 729 comprise channels, such as microfluidic channels that extend from and branch off of primary separation passage 626. Separation passages 728, 729 lead to distinct destinations where the separated particles or cells may be collected and analyzed. In the example illustrated, separation passages 728, 729 extend in a single plane, such as a single horizontal plane. In some implementations, separation passages 728, 729 extend in the same plane as separation passage 726. Although passages 728, 729 are illustrated as branching off of separation passage 626 at angles of 135°, it should be appreciated that passages 728, 729 may extend at other angles from separation passage 626.

Secondary separation passages 738, 739 comprise channels, such as microfluidic channels, that extend from and branch off of primary separation passage 636. Separation passages 738, 739 lead to distinct destinations where the separated particles may be collected and analyzed. In the example illustrated, separation passages 738, 739 extend in a single plane, such as a single horizontal plane. In some implementations, separation passages 738, 739 extend in the same plane as separation passage 636. Although passages 738, 739 are illustrated as branching off of separation passage 636 at angles of 135°, it should be appreciated that passages 738, 739 may extend at other angles from separation passage 636.

Electrodes 740 are provided to create electric fields across secondary separation passages 728, 729, 738, 739. Electrodes 740 extend in a single plane such that they produce electric field that extends in the same plane as that of passages 624, 626 and 636 as well as passages 728, 729, 738, 739. Because the separation passages, the electric field and the dielectrophoretic force extend in a single plane, the separation of particles is more predictable and less chaotic, producing more reliable results.

In the example illustrated, electrode 740A extends alongside passages 728, 729. Electrode 740B extends alongside passages 738, 739. Electrode 740A cooperates with electrode 640A to establish an electric field across secondary separation passage 728. Electrode 740A cooperates with electrode 640C to establish field across secondary separation passage 629. Electrode 740B cooperates with electrode 640C to establish field across secondary separation passage 738. Electrode 740B cooperates with electrode 640B to establish an electric field across secondary separation passage 739. As should be appreciated, each of electrodes 640A, 640B and 640C, may be a continuous electrode or may be formed by multiple separate elements connected to ground or a source of electrical current, such as an alternating frequency electric current source.

In one implementation, electrodes 640A and 740A are separated by a distance across secondary separation passage 328 by distance of at least 10 times a diameter of a target particle to be separated. Likewise, electrodes 740A and 640C, electrodes 740B and 640C and electrodes 740B and 640B are also separated by distance across separation passages 729, 738 and 739, respectively, by a distance of at least 10 times a diameter of the target particle(s) being separated. This separation reduces the likelihood that the global electric field will not be significantly distorted by the presence of the particle such that similar separations are carried out on all particles in the flow.

Particle separator 760 performs multi-staged DEP particle separation. In the example illustrated, the flow of fluid containing the particles to be separated is directed along inlet passage 624. The electric fields extending across passage 624 as well as passages 626 and 636 create dielectrophoretic forces that differently direct with different particles based upon differences in particle size and electric polarity. The different responses of the different particles to the dielectrophoretic forces results in the flow of fluid splitting, with a first portion of particles being diverted along separation passage 626 and a second portion of the particles being diverted along separation passage 636. Thereafter, the electric fields created across passages 728 and 729 create dielectrophoretic forces that differently interact with different particles within separation passage 626 based upon differences in particle size and electric polarity to further split the stream of particles within separation passage 626 such that a first portion is further diverted along separation passages 728 and a second portion is further diverted along separation passage 729.

Likewise, the electric fields created across passages 738 and 739 create dielectrophoretic forces that differently direct with different particles within separation passage 636 based upon differences in particle size and electric polarity to further split the stream of particles within separation passage 636 such that a first portion is further diverted along separation passages 738 and a second portion is further diverted along separation passage 739. As a result, the original stream of fluid entrained particles received from passage 580 is separated into four different sets of particles or groups of particles. Each group of particles has particles of similar sizes and/or electric polarities. Each group of particles has particles that are sized or that have electrical polarities different than particles of other groups. The different groups or sets of particles may be directed further downstream to respective particle/fluid collection/disposal ports or reservoirs, such as ports or reservoirs 656, 666 shown in FIG. 7.

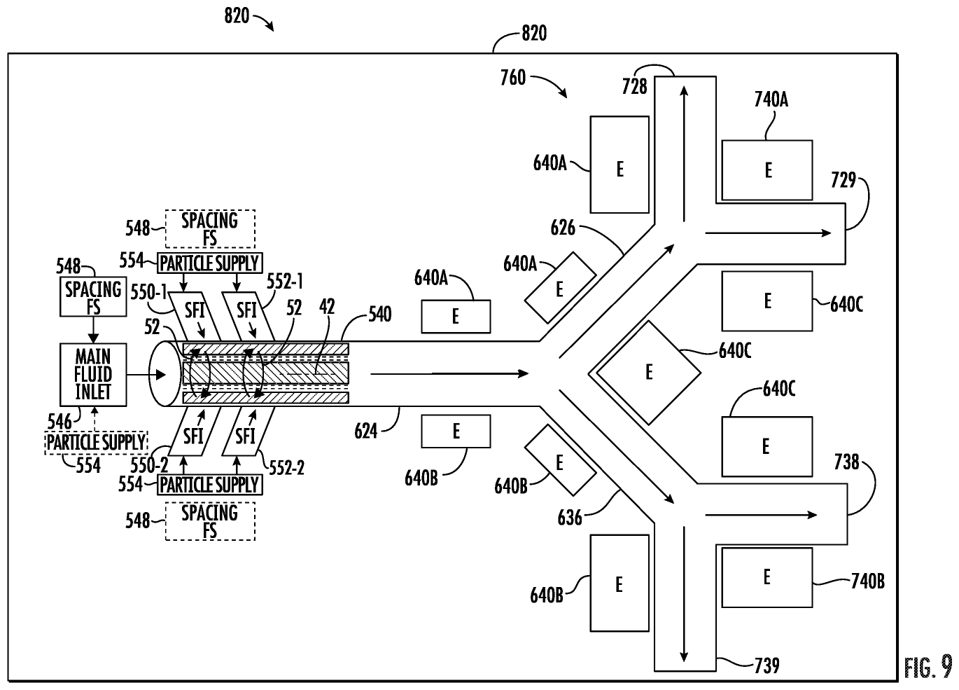

FIG. 9 is a perspective view illustrating portions of an example fluid entrained particle separation system 820, with portions schematically shown. Similar to system 620, system 820 is formed as part of a microfluidic chip 821, wherein the fluid channel or passage is comprised microfluidic channel or passages formed on a substantially flat planar base or substrate. In other implementations, system 820 may be formed as separate components which are connected to one another for the channeling of fluid between such components. System 820 is similar to system 620 described above except that system 820 omits particle separator 560. Those remaining components of fluid entrained particle separation system 820 which correspond to components of fluid entrained particle separation system 620 are numbered similarly.

System 820 functions similar to system 720 except that particle separator 660 interacts directly with both of the different material concentrations, the lighter material 54 and the heavier material 56. Because the lighter material 54 and the heavier material 56 are concentrated in two different and predetermined regions prior to entering separator 660, the location of the particles of interest or particles to be separated out from the fluid have a more predictable location. For example, lighter material 54, such as white blood cells, may be predictably proximate to axis 42 as compared to the heavier red blood cells which are predictably distant from axis 42. As a result, the DEP forces exerted by the electrodes 640 and 740 may be more precisely and accurately tuned to the predicted locations of the particle of interest for enhanced or more “clean” separation. Even though the electrodes 640, 740 may generate strong nonuniform fields, because particles having the same density properties travel through the same regions and experience the same forces, particles/cells of the same or similar densities are interacted upon or pushed by the forces consistently into different regions or separation passages. As a result, the separation of particles of interest or target particles from other non-targeted particles may be more consistent and repeatable.

Although system 820 is illustrated as comprising the multistage DEP particle separator 660, in other implementations, system 820 comprise the single stage DEP particle separator 660 shown and described above with respect to system 620. In such an implementation, system 820 omits secondary separation passages 728, 729, 738, 739 and electrodes 740A, 740B (collectively referred to as electrodes 740). As should be appreciated, in still other implementations, system 820 may comprise additional downstream particle separation stages such as additional DEP particle separation stages and additional downstream particle/fluid collection/disposal ports or reservoirs.

Although the present disclosure has been described with reference to example implementations, workers skilled in the art will recognize that changes may be made in form and detail without departing from disclosure. For example, although different example implementations may have been described as including features providing various benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A fluid entrained particle separation system comprising:
a particle separator;
a main fluid passage extending along an axis to guide translational fluid flow along the axis to the particle separator;
a side fluid inlet connected to the main fluid passage to generate a vortex about the axis, the vortex concentrating less dense material in the fluid flow towards the axis.

2. The system of claim 1, wherein the particle separator comprises:
a first separation passage extending from the main fluid passage to receive the less dense material that is concentrated towards the axis; and
a second separation passage extending from the main fluid passage to receive material other than the less dense material.

3. The system of claim 2 further comprising a second particle separator connected to the first separation passage to further separate particles entrained in fluid flowing through the first separation passage.

4. The system of claim 3, wherein the second particle separator comprises a dielectrophoretic (DEP) particle separator.

5. The system of claim 4, wherein the DEP particle separator comprises:
a first separation passage branching from the main fluid passage;
a second separation passage branching from the main fluid passage;
electrodes to create electric field exerting a DEP force on the particles to direct the particles to the first separation passage or the second separation passage, wherein the first separation passage, a second separation passage, the electric field and the DEP force extend in a plane.

6. The system of claim 1, wherein the particle separator comprises a dielectrophoretic (DEP) particle separator.

7. The system of claim 6, wherein the DEP particle separator comprises:
a first separation passage branching from the main fluid passage;
a second separation passage branching from the main fluid passage;
electrodes to create electric field exerting a DEP force on the particles to direct the particles to the first separation passage or the second separation passage, wherein the first separation passage, a second separation passage, the electric field and the DEP force extend in a plane.

8. The system of claim 1, wherein the fluid inlet is on a first side of the axis, the system further comprising a second fluid inlet on a second side of the axis.

9. The system of claim 1 further comprising a main fluid inlet connected to the main fluid passage, the side fluid inlet located between the main fluid inlet and the particle separator.

10. The system of claim 1 further comprising a second side fluid inlet connected to the main fluid passage and spaced from the side fluid inlet in a direction along the axis.

11. The system of claim 1, wherein the main fluid passage comprises a rifled interior surface.

12. The system of claim 1, wherein the side fluid inlet is to direct fluid flow into the main fluid passage at an angle oblique to a horizontal or vertical plane intersecting the axis.

13. A method for separating particles entrained in a fluid, the method comprising:
generating a vortex within a fluid flow within a main fluid passage extending along an axis to a particle separator to concentrate less dense material towards the axis;
translating the concentrated less dense material along the axis to the particle separator.

14. The method of claim 13, wherein the particles of the fluid flow to be separated comprise first particles having a first density and second particles having a second density, the method further comprising suspending the first particles and the second particles in a spacing fluid having a third density between the first density and the second density.

15. A fluid entrained particle separation system comprising:
a particle separator;
a main fluid passage extending along an axis to the particle separator;
a main fluid inlet to supply a translational fluid flow along the axis;
a side fluid inlet to generate a vortex within the main fluid passage;
a particle supply connected to one of the main fluid inlet and the side fluid inlet, the particle supply to supply first particles having a first density and second particles having a second density;
a spacing fluid supply connected to the other of the main fluid inlet and the side fluid inlet, the spacing fluid supply to supply a fluid having a third density between the first density and the second density.
